(19) United States
(12) Patent Application Publication
(10) Pub. No.: US 2015/0287224 A1
(43) Pub. Date: Oct. 8, 2015

(54) VIRTUAL TRACER METHODS AND SYSTEMS

(71) Applicant: Technology Service Corporation, Silver Spring, MD (US)

(72) Inventors: William W. HOOPER, Owens Cross Roads, AL (US); Michael A. JOHNSON, Owens Cross Roads, AL (US)

(73) Assignee: Technology Service Corporation

(21) Appl. No.: 14/503,314

(22) Filed: Sep. 30, 2014

Related U.S. Application Data
(60) Provisional application No. 61/885,175, filed on Oct. 1, 2013.

(51) Int. Cl. G06T 11/20; G01B 11/00; G06K 9/00

(52) U.S. Cl. CPC G06T 11/203; G06K 9/00624; G01B 11/00

(57) ABSTRACT

A virtual tracer system and methods for operating the system to track a moving object are disclosed. The virtual tracer system may transmit a continuous waveform signal to a plurality of projectiles traveling in an outbound direction with respect to a carrier of the system. The virtual tracer system may further receive a signal reflected from the projectiles in response to the transmitted continuous waveform signal, and may determine a track of the projectiles based on the reflected signal.

### CROSS-REFERENCE TO RELATED APPLICATIONS

The present application claims the benefit of priority of U.S. Provisional Patent Application No. 61/885,175, filed Oct. 1, 2013, the disclosure of which is expressly incorporated herein by reference in its entirety.

### TECHNICAL FIELD

The present disclosure relates generally to the field of virtual tracer systems for tracking and displaying projectiles. More specifically, the present disclosure relates to methods and systems for tracking and displaying projectiles by processing electromagnetic signals reflected from the projectiles, using sensor arrays.

### BACKGROUND

The ability to track an object is very important in many military and civilian applications. In military applications, for example, tracer bullets are regularly used to allow a gunner (or an operator) to see the trajectory of bullets leaving a gun system so that the operator may adjust the firing angle to strike the operator's intended target. In particular, tracer bullets are mixed with regular bullets and emit light or smoke with distinct colors or other signals, thereby providing visual feedback to the operator. The visual feedback provided by the tracer bullets is especially important in challenging environments such as firing from a moving platform. Differences between the flight characteristics of the tracer bullets and the regular bullets, however, degrade the accuracy of the visual feedback. In addition, tracer bullets are more expensive than regular bullets. Tracer bullets may also indicate the operator's position to enemies, thereby compromising the operator's safety. Further, tracer bullets do not penetrate as effectively as regular bullets.

### SUMMARY

Consistent with a disclosed embodiment, a method for detecting a moving object is disclosed. The method comprises transmitting a continuous waveform signal in a direction of a plurality of projectiles traveling in an outbound direction with respect to a carrier, from which the projectiles are discharged. The method further comprises receiving a signal reflected from the projectiles in response to the continuous waveform signal, and determining a track of the projectiles based on the reflected signal.

In another disclosed embodiment, a system for detecting a moving object is disclosed. The system includes, a transmitter that is configured to transmit a continuous waveform signal toward a plurality of projectiles traveling in an outbound direction with respect to a carrier of the system, from which the projectiles are discharged. The system further includes a receiver that is configured to receive a signal reflected from the projectiles in response to the continuous waveform signal, and a processor that is configured to determine a track of the projectiles based on the reflected signal.

In another embodiment, a system for simulating detection of a moving object is disclosed. The system comprises a processor configured to generate a simulation signal representing a returned signal reflected from a plurality of simulated projectiles in response to a continuous waveform signal and determine a track of the simulated projectiles based on the simulation signal. The system further comprises a display device configured to generate a graphical representation of the track.

Additional objects and advantages of the invention will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure, as claimed.

The accompanying drawings, which are incorporated in and constitute a part of this specification, illustrate several embodiments of the disclosure and together with the description, serve to explain the principles of the disclosure.

### BRIEF DESCRIPTION OF THE DRAWINGS

FIG. 1 depicts an exemplary virtual tracer system integrated with a gun system and a vehicle consistent with embodiments of the present disclosure.

FIG. 2 depicts an exemplary tracking system of the virtual tracer system consistent with embodiments of the present disclosure.

FIG. 3 depicts a diagram of an exemplary tracking system consistent with embodiments of the present disclosure.

FIG. 4 depicts a flowchart of an exemplary method for detecting and displaying projectiles.

### DETAILED DESCRIPTION

Reference will now be made in detail to the present embodiments of the disclosure, examples of which are illustrated in the accompanying drawings. Wherever possible, the same reference numbers will be used throughout the drawings to refer to the same or like parts.

According to an embodiment, a virtual tracer system collects data or signals related to a trajectory of projectiles (e.g., bullets). The system includes a processor that may process the data, and a display to display a graphical representation of the trajectory. For example, the system may emit an electromagnetic waveform toward the bullets as they leave the muzzle and measure the return signal to determine the cross section and resolution of the bullets as they travel throughout space. Since the system is able to resolve the bullets, the system may determine the trajectory of each individual bullet. The trajectory of the bullets provides a near real-time feedback loop and enables the operator to reposition the gun system so as to hit the target. This may minimize the number of bullets used, and the chances that an adversary may track the source of the bullets.

In order for the operator to watch the bullets as they travel toward the target, one or more processors and a display device may be used to render the return signals generated by the system and display the bullets in near real time as they are moving. The resolution requirements of the display may enable an operator to properly aim a gun system at the intended target , and to determine if the intended area of a target has been hit or missed. As a result, commercial grade displays may be suitable for displaying the images rendered by the processors.

The virtual tracer system disclosed herein addresses the shortcomings of the existing tracing techniques, and presents alternative methods and systems that may provide substantial cost savings. According to one aspect of the disclosure, the virtual tracer system includes a tracking system (e.g., a radar system) configured to detect and track a tracked object, such as outgoing ammunition, or other projectiles, from a gun system (e.g., bullets). The tracking system detects objects with small cross sections, and therefore may track individual bullets as they traverse between the muzzle of the gun system and the place of impact on the intended target.

According to another aspect of the disclosure, the virtual tracer system includes a display device configured to provide a visual representation of a track or trajectory of the outbound ammunition from the gun system. The low latency of the radar system provides a substantially real-time display of the trajectory of the outbound ammunition, thereby providing an operator of the virtual tracer system with real-time visual feedback. The visual feedback allows the operator to correct his or her aim, and to adjust the firing angle according to the trajectory of the ammunition displayed on the display device. The virtual tracer system of the present disclosure may eliminate the need for the conventional tracer bullets and, thus, avoids the aforementioned drawbacks of the existing tracing techniques.

According to yet another aspect of the disclosure, the virtual tracer system includes one or more processors that process signals reflected from outbound ammunition. The electromagnetic signals may be generated by the tracking system in some embodiments. In other embodiments, the electromagnetic signals may be generated by a standalone transmitter. The processor may perform signal processing techniques to determine the cross-section of each unit of ammunition (e.g., each individual bullet), and may render an image of each unit of ammunition for presentation on the display device.

In one embodiment of the virtual tracer system described herein, the system may use the following characteristics to determine the settings for the virtual tracer system. The virtual tracer system may be operative in day or night time conditions. In some embodiments, weather conditions may affect the operation of the virtual tracer system. For example, during periods of heavy precipitation (e.g., rain, sleet, and/or snow) certain parameters of the virtual tracer system may need to be adjusted to accurately distinguish the precipitate from the projectiles.

One or more parameters may be associated with the accuracy of the angle of the electromagnetic waves emitted from the virtual tracer system. For instance the indicated angle of accuracy may be greater than 5 milliradians.

The virtual tracer system may also be configured to receive inputs that correspond to an unambiguous range of the virtual tracer system. For example, in some embodiments the unambiguous range over which the virtual tracer system may accurately display a return signal from a projectile may be adjusted by adjusting the pulse repetition of the virtual tracer system. In one embodiment, the unambiguous range of the virtual tracer system may be 2 kilometers.

Other virtual system parameters that may be considered during the development of the virtual tracer system may include the total system weight, the power draw, the range of Doppler processing compatible with the vehicle, upon which the virtual tracer system is mounted, the volume of space that electromagnetic signals emitted from the virtual tracer system may cover (i.e., degree of coverage), and the compatibility of the virtual tracer system with a particular beamformer.

For example, virtual tracer system parameters associated with the volume of space, over which the electromagnetic signals cover, and parameters associated with the probability of the electromagnetic signals being detected by an adversary (i.e., probability of detecting the beamformer) may be optimized given an objective of the operator of the virtual tracer system. For instance, an operator may adjust the volume of space covered by the electromagnetic signal in order to lower the probability of detection of the beamformer (i.e., transmitters) in the virtual tracer system.

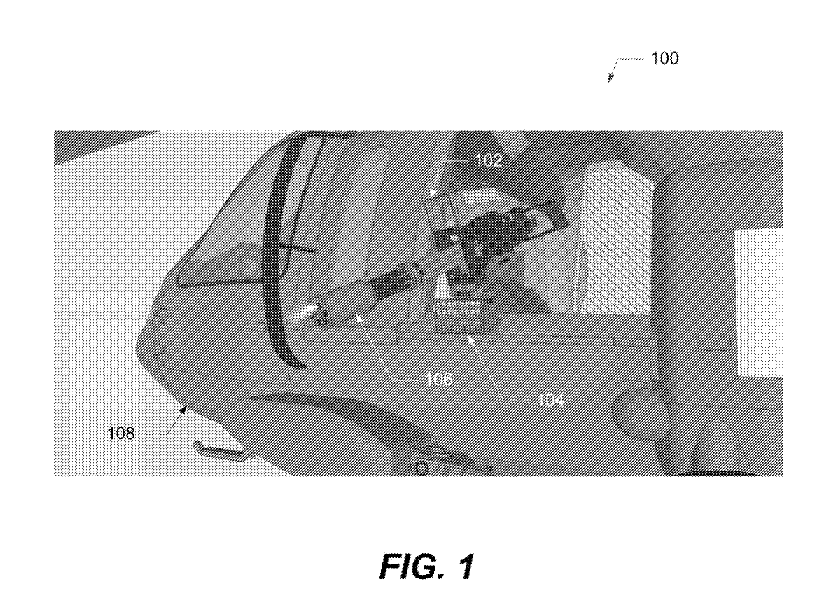

FIG. 1 depicts an exemplary virtual tracer system 100 integrated with a gun system and a carrier platform, such as a vehicle, consistent with embodiments of the present disclosure. Virtual tracer system 100 is disclosed in the context of a gun system (e.g., gun system 106) mounted on a helicopter (e.g., helicopter 108). Virtual tracer system 100 includes a tracking system 104 (e.g., a radar system) configured to detect and track objects, such as outgoing bullets shot from gun system 106, and a display device (e.g., display device 102) to show the operator the paths the bullets are traversing (i.e., the track or trajectory of the bullets).

According to a further embodiment, display device 102 is mounted on gun system 106 and in front of an operator. Optionally, if display device 102 is mounted on gun system 106, system 100 may further include a modified gun mount to automatically determine a pointing angle of gun system 106 and automatically update display device 102 to match the pointing angle when the weapon is slewed.

In some embodiments, system 100 may include a position or motion sensor (not shown in FIG. 1) configured to automatically determine the pointing angle of a gun system. For instance, based on signals generated by the position or motion sensor, virtual tracer system 100 may provide a visual representation of the pointing angle of gun system 106 on display device 102 based on signals generated by the position or motion sensor. In some embodiments, the visual representation may be updated in substantially real time to match a position of gun system 106.

According to another embodiment, virtual tracer system 100 may include a navigation unit (not shown in FIG. 1). For instance, based on information provided by the navigation unit, outgoing virtual tracer information may be integrated with hostile ground target and blue force (i.e., friendly force) information on the display device. According to one embodiment, tracking system 104 may be smaller than a belt feed 30 caliber ammunition canister, so that the entire virtual tracer system 100 may be integrated into the gun mount.

According to a disclosed embodiment, tracking system 104 meets the exemplary requirements set forth in Table 1.

TABLE 1
Exemplary System Requirements.

| Design Parameter | Value |
|---|---|
| Minimum Object to be Tracked | 7.62 mm (−45 dBsm RCS) |
| Maximum Object Velocity | 1000 m/s |
| Minimum Object Velocity | 100 m/s |
| Max Sensor Area | 6″ × 6″ |
| Search Volume | 120 deg × 90 deg |
| System Weight | Less than 50 lbs |
| System Power | 1% of vehicle aux generator |
| Indicated Angle Accuracy | Better than 5 mrad |

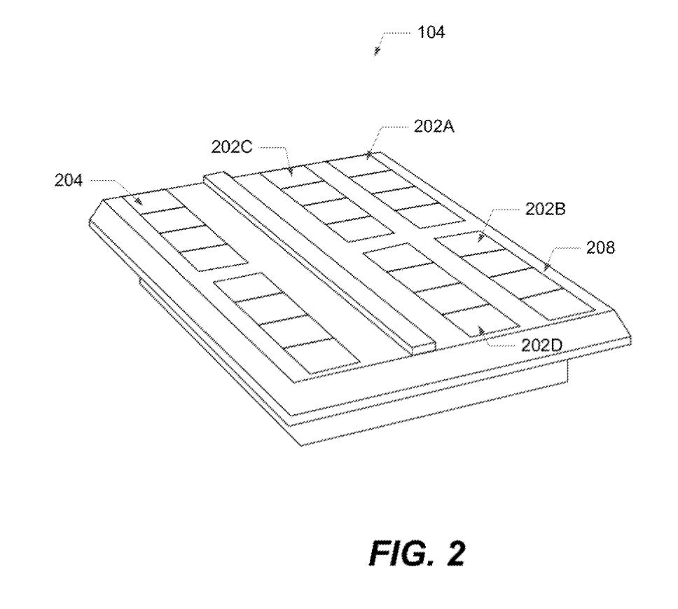

FIG. 2 depicts an exemplary tracking system consistent with embodiments of the present disclosure. As shown in FIG. 2, tracking system 104 may include radar transmitting arrays 204A-204B and radar receiving arrays 202A-202D mounted on plate 208. Radar transmitting arrays 204A-204B and receiving arrays 202A-202D may be separated by a partition 206 to provide isolation. Radar transmitting arrays 204A-204B and receiving arrays 202A-202D may be arranged such that the surface of radar transmitting arrays 204A-204B and receiving arrays 202A-202D are even with the surface of plate 208 of tracking system 104. The surface of plate 208 of tracking system 104 may be larger in some embodiments and smaller in others. For example, in one embodiment, plate 208 may have a rectangular geometry with equal sides (e.g., 6 x 6 inches). Receiving arrays 202A-202D and transmitting arrays 204A-204B include broadband patch elements capable of supporting a bandwidth required by tracking system 104.

As further shown in FIG. 2, receiving arrays 202A-202D may include 16 receiving elements. Each receiving array (e.g., 202B) may comprise four receiving elements. The elements of receiving arrays 202A-202D may be configured to form multiple radar system beams. In one embodiment, the beam width of a signal incident upon receiving arrays 202A-202D in an azimuthal direction may be 120 degrees, while the beam width in an elevation direction may be 90 degrees. Thus, the reflected radar system beam incident on receiving arrays 202A-202D may cover a search volume corresponding to the azimuthal direction, an elevation direction, and a given distance between receiving arrays 202A-202D and an object of interest (e.g., a bullet). Other beam widths may also be implemented. The radar system beam formed by transmitting arrays 204A-204B and received by receiving arrays 202A-202D, may be steered via digitally controlled phase shifters to a desired location or direction.

Tracking system 104 may have parameters that determine the size (i.e., cross-section or diameter) of the projectile being tracked. In one embodiment, the parameters of tracking system 104 may be adjusted to track bullets with a diameter of 0.308 inches (i.e., .30 caliber). In another embodiment, the parameters of tracking system 104 may be adjusted to track bullets with a diameter of 7.62 millimeters, which corresponds to a radar system cross section of −45 dBsm. In yet another embodiment, the parameters of tracking system 104 may be adjusted to track a bullet with a maximum velocity of 1,000 meters per second and/or a minimum velocity of 100 meters per second. Tracking system 104 may require power sources, but may be configured to draw power from a power source of a vehicle, upon which system 100 is mounted. In some embodiments the power source may be an auxiliary power source or integrated with system 100.

Transmitting arrays 204A-204B may transmit electromagnetic signals that have a certain shape, volume, frequency, and modulation. In some embodiments, transmitting arrays 204A-204B may transmit a signal having a frequency-modulated continuous-wave (FMCW) waveform. Other time or frequency-modulated signals, including either continuous waveforms or pulses, may also be employed. The transmitted signal may be reflected and returned from the outbound bullets. The returned signals may be received by receiving arrays 202A-202D. Transmitting arrays 204A-204B may include a structure similar to that of receiving arrays 202A-202D, including a plurality of transmitting elements. Transmitting arrays 204A-204B may be configured to broadcast a signal or may form a radar system beam directed towards a specific object, such as outgoing bullets or other projectiles.

The FMCW waveform is an electromagnetic signal that is continuously transmitted by tracking system 104. A pulse waveform may be generated by tracking system 104, and may be a waveform that is not continuously transmitted over time, but in intervals (i.e., periods). Transmitting arrays 204A-204B may vary the frequency of the transmitted signal over time by selecting a frequency from a contiguous group of frequencies (i.e., from a certain bandwidth). In some embodiments the frequencies selected may not be selected from a group of contiguous frequencies, but may be selected from groups of discontiguous frequencies.

The difference in frequency between the transmitted and received signals may be determined by mixing the two signals and further used to determine the distance and velocity of the outgoing bullets. The waveform used in the FMCW waveform signal may be a sinusoidal waveform, sawtooth waveform, triangle waveform, square waveform, and/or any combination of these waveforms. A processor (e.g., processor 302) may process the FMCW waveform signal by applying Doppler signal processing techniques, which allows tracking system 104 to detect objects as small as individual bullets with a beneficial degree of immunity from interference from large stationary objects and slow moving objects.The FMCW waveform signal may enable tracking system 104 to determine the range of the outgoing bullets with velocity information of the individual bullets.

According to a still further embodiment, receiving arrays 202A-202D may include monolithic microwave integrated circuit (MMIC) devices. The MMICs may be used to perform the mixing operation described above, amplify received signals so that other components of the MMICs may properly reconstruct an image of the projectiles, and/or perform frequency switching to match the frequencies of the received signals with the frequencies of oscillators in the MMIC. The element may be configured to down-convert the received radio-frequency (RF) signals to intermediate frequency (IF) signals. Each element may further include a bank of analog-to-digital converters (ADCs) configured to digitally sample the down-converted IF signals.

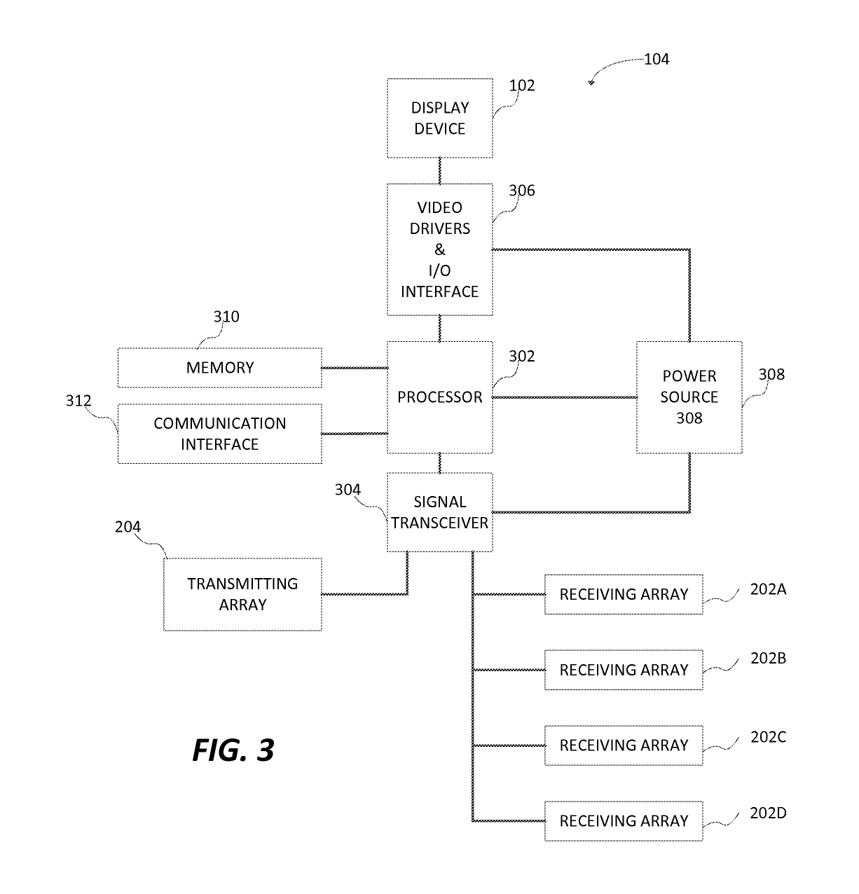

FIG. 3 depicts an exemplary virtual tracer system 104 consistent with embodiments of the present disclosure. Tracking system 104 may further include processors 302 configured to control the operation of transmitting and receiving arrays 202A-202D and 204 and process signals received from receiving arrays 202A-202D. Processor 302 may include a central processing unit (CPU), a Field-Programmable Gate Array (FPGA), or other circuits known in the art. Processor 302 may be configured to process range, Doppler, and monopulse angles of received signals.

According to a further embodiment, processor 302 may control tracking system 104 to detect outgoing bullets based on range-Doppler imaging (RDI). For instance, processor 302 may process received signals from receiving arrays 202A-202D and may generate a series of two-dimensional images indicating the track of outgoing bullets. Processor 302 may use RDI to track the range of outgoing bullets, develop Doppler profiles of bullets, and estimate the amount of noise generated by receiving arrays 202A-202D. Estimating the noise generated by a platform upon which tracking system 104 may be mounted, and the terrain-induced phase noise may enable tracking system 104 to implement a robust Constant False Alarm Rate (CFAR) processing mechanism. The CFAR processing mechanism may ensure that detailed feature tracking may be implemented by processor 302. The CFAR mechanism also enables tracking system 104 to perform automatic detection, mitigation, and recovery from noise and tone interference.

Tracking system 104 may further include a signal transceiver 304 configured to supply signals to transmitting device 204 and receive signals from receiving arrays 202A-202D. Tracking system 104 may further include video drivers and I/O interfaces 306, which may be configured to communicate with display device 102. Video driver and I/O interface 306 may receive imaging data from processor 302 and transmit the imaging data to display device 102. Tracking system 104 may further include a power source 308, which may be a battery, configured to provide power to components of tracking system 104. Alternatively, power source 308 may include an interface configured to receive electric power from an external source such as a power system of an aircraft, an automobile, or a vessel. Alternatively, any suitable power source may be used. Additionally, tracking system 104 may further include memory 310, such as a RAM, a ROM, a hard drive, a flash drive, etc., configured to store computer instructions. Processor 302 may execute the computer instructions from memory 310 to process the received signals and provide outputs on, for example, display device 102. Memory 310 may also store the processing results and any data relevant to the processing of the received signals.

According to a further embodiment, tracking system 104 may further include communication interface 312 for receiving position signals from a position sensor coupled to gun system 106. The position sensor may determine a pointing direction of the gun system 106 and transmit the position signals to tracking system 104. Processor 302 may receive the position signals through communication interface 312 and update the imaging data based on the position signals to indicate the updated pointing direction of gun system 106. Alternatively, communication interface 312 may communicate with a navigation system and receive navigation signals therefrom. Based on the navigation signals, processor 302 may determine a position of a hostile force or a friendly force with respect to gun system 106 and display the position of the hostile force or the friendly force on display device 102.

The processing of the received signals may be performed within tracking system 104 to minimize the installation impact and increase the robustness of the system. According to one embodiment, receiving arrays 202A-202D and transmitting arrays 204A-204B may include more or less than four elements.

Tracking system 104 may be adjusted in addition to the parameters listed above. In particular, the transmit power, frequency, antenna gain, antenna beam width, and periodicity, with which tracking system 104 scans through a search volume, may be adjusted based on a return signal from the projectiles. For example, the transmit power may be increased to trace the trajectory of the bullets for a further distance. For instance, a first transmit power may correspond to a distance that tracking system 104 may send, receive, and accurately render an image of the bullets. If the transmit power is increased to a second transmit power, greater than the first transmit power, the distance that tracking system 104 may send, receive, and render images of the bullets will be greater than the distance corresponding to the first transmit power. In some embodiments, these parameters may be adjusted in response to electromagnetic return signals reflected from the outgoing bullets.

Other parameters controlling the operation of tracking system 104 that may be adjusted may include the periodicity, with which tracking system 104 focuses (i.e., dwells) on a certain area within a search volume, the number of electromagnetic signals that may be cast onto a bullet simultaneously, and the bandwidth of the return signal, over which tracking system 104 may filter out undesired signals. For example, tracking system 104 may be configured to filter out signals that oscillate at a frequency that is not within a designated bandwidth.

Further still, tracking system 104 may also be adjusted according to additional parameters including, the signal loss, the noise figure, and the minimum signal-to-noise ratio. In some embodiments signal loss may be attributed to atmospheric losses, beam shape losses, filter matching losses, fluctuation losses, receiver losses, and/or transmitter losses. Accordingly, tracking system 104 may be designed in such a way to minimize these losses. Similarly, the noise figure and minimum signal-to-noise ratio may also be factored into the design of tracking system 104. In other embodiments, these parameters may or not be factored into the design, and may be compensated for through the use of pre-processing and/or post-processing techniques applied to the transmitted and/or received signals. For example, processor 302 may perform pre-processing techniques on a signal before it is transmitted by transmitting arrays 204A-204B to compensate for losses, the noise figure, and/or the signal-to-noise ratio not being above a certain number. Alternatively, processor 302 may perform post-processing techniques on a received signal to compensate for losses, the noise figure, and/or the signal-to-noise ratio not being above a certain number. Exemplary parameters are set forth below in Table 2.

TABLE 2
Radar Parameters.

| Design Parameter | Value | |
|---|---|---|
| Pₜ (peak) | 3 | W |
| Frequency | 10 | GHz |
| Antenna Gain | 16 | dB |
| Antenna Beamwidth | 120 deg × 90 deg | |
| Search Volume | 120 deg × 90 deg | |
| t_{scan} | 10 | msec |
| t_{dwell} | 1 | msec |
| N_{beams} | 10 | |
| Detection Bandwidth | 1 | kHz |
| Losses | 10 | dB |
| Noise Figure | 5 | dB |
| SNRₘᵢₙ | 10 | dB |

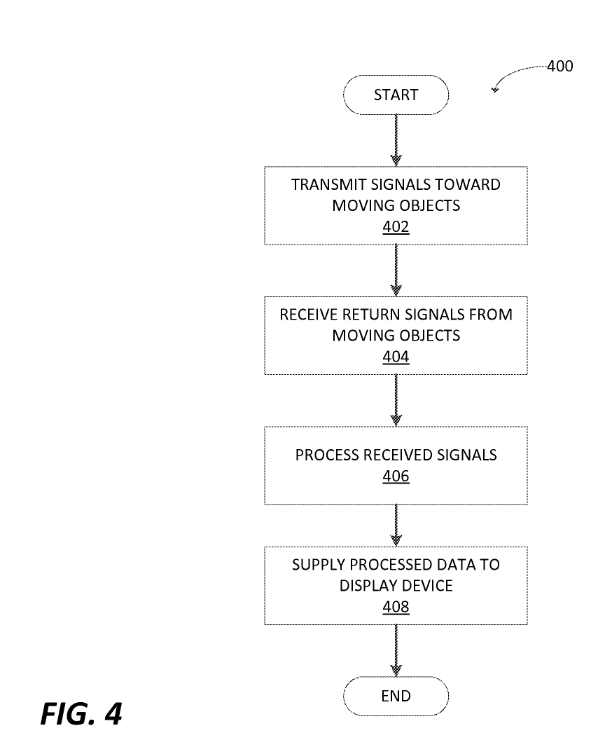

FIG. 4 depicts a flowchart of an exemplary method 400 for detecting and displaying a projectile. Method 400 may be implemented by tracking system 104. Method 400 may include transmitting a signal from a virtual tracking system (e.g., virtual tracking system 104), including a continuous waveform (e.g., the FMCW), a modulated pulse waveform, and/or other modulated or un-modulated signals (step 402). The signal may be transmitted by a transmitting device (transmitting device 204) toward moving objects (e.g., bullets). After the transmitting device has transmitted a signal toward the moving objects, in step 402, receiving arrays 202A-202D may receive signals corresponding to reflections of the transmitted signals from the moving objects (step 404).

At step 406, processor 302 may process the received signals to determine locations of the moving objects relative to tracking system 104. Processor 302 may process the received signals according to range-Doppler imaging and generate a two-dimensional representation of the moving objects indicating a velocity of the moving objects and a distance to the moving objects. At step 408, processor 302 may supply data including image data of the moving objects to a display device (e.g., display device 102). After display device 102 receives the image data, it may render an image to a user.

According to a further embodiment, steps 404-408 may be performed repeatedly at regular time intervals, or repeated as frequently as desired. Accordingly, tracking system 104 may update the two-dimensional image on display device 102 to indicate a track or trajectory of the moving objects. Thus, tracking system 104 may provide a real-time visual feedback to the user displaying the location and the track of the moving objects.

In some embodiments, a weapon (e.g., gun system 106) may also be adjusted based on the trajectory of the moving object. For example, after processor 302 processes the received signal, processor 302 may send a signal to an actuator connected to the weapon that automatically adjusts the position of the weapon based on the trajectory (or track) of the moving objects. The position of the weapon may be adjusted so that the moving objects hit the intended target. In other embodiments, the weapon may be adjusted simultaneously while the trajectory of the moving objects is displayed on display device 102.

Virtual tracer system 100 described above may provide the benefits of immediate visual feedback to an operator of a weapon system while mitigating the disadvantages of detection by an adversary. Virtual tracer system 100 may improve the firing accuracy and reduce the ammunition cost associated with conventional tracer bullets, and may be provided as an add-on to a gun system for use with a single weapon or integrated with a plurality of weapon systems in an airframe to provide greater capability. In addition, virtual tracer system 100 has a relatively small size and a fast detection speed, providing updated information on outgoing bullets every few micro seconds. The power consumption of virtual tracer system 100 is relatively low and may be satisfied by a battery or an on-board power system of the carrier vehicle. The cost of manufacturing and maintaining virtual tracer system 100 is relatively low, compared with the conventional tracing techniques. Because of the small size and light weight, virtual tracer system 100 may be portable and carried by an operator onto a field (e.g., a battle field).

Virtual tracer system 100 may be integrated in various weapon systems, such as the M60D, the M3M/Gau-21, or the M134/Gau-17A. Virtual tracer system 100 may also be integrated in various carrier vehicles, such as automobiles, aircraft, or water vessels. Virtual tracer system 100 may provide accurate measurements of outgoing bullets from gun system 106 despite interference due to motion of the carrier vehicles.

According to an alternative embodiment, tracking system 104 may operate in a simulation mode that uses blank bullets or no bullets at all. Tracking system 104 may simulate tracking of bullets fired from gun system 106 by simulating the transmission of a waveform signal toward the bullets, and simulating the returned signal and the processing of the returned signal. For example, processor 302 may generate a simulation signal representing a returned signal reflected from a plurality of simulated outgoing bullets and then process the simulation signal to determine a track of the simulated bullets. Display device 102 may display images of the outgoing bullets based on the simulation signal. In other embodiments, processor 302 may simulate transmission, reception, and processing of a waveform signal in order to simulate the outgoing bullets. In particular, processor 302 may generate the simulation signal by simulating a reflection of the continuous waveform signal by the bullets.

According to an additional embodiment, display device 102 may be integrated in a head-mounted display (HMD) unit, such as a pair of electronic goggle, a pair of glasses, a helmet, etc., which may be worn by an operator. In this embodiment, display device 102 may display the trace of outgoing bullets and other information described above in front of the operator's eyes, while allowing the operator to see through display device 102. Thus, virtual tracer system 100 may allow the operator to view the environment while shooting so as to adjust a weapon (e.g., gun system 106) to bring the shooting on target based on the track displayed on display device 102.

According to an additional alternative embodiment, virtual tracer system 100 may be used to detect any object that has a relative motion with respect to tracking system 104. For example, virtual tracer system 100 may be integrated in an auto pilot system for operating a vehicle, such as an automobile, a plane, or a vessel, with no or minimal human interactions and monitoring. In such an embodiment, virtual tracer system 100 may detect locations and speeds of moving objects, such as obstacles, buildings, or other vehicles, around the vehicle and provide detection results to a control system for controlling the vehicle to avoid the objects. Alternatively, tracking system 104 may detect the presence of guiding objects, such as guiding poles or road marks, and provide detection results to a control system to guide vehicles along a specific route.

In some embodiments, tracking system 104 may provide collision avoidance. For example, system 104 may monitor the objects, such as pedestrians or other vehicles, and provide an indication or warning to an operator of the vehicle to take necessary precaution to avoid collision with the objects.

In other embodiments, system 104 may identify and detect hostile fire and provide warnings or indications to the operator so as to avoid the hostile fire. For example, tracking system 104 may detect incoming bullets associated with the enemy or hostile force based on returned signals from the incoming bullets. Processor 302 may determine a track of the incoming bullets and a distance between the incoming bullets and the carrier platform. Processor 302 may then generate indication on a display (e.g., device display 102) indicating which bullets correspond to hostile force (i.e., incoming bullets) and which bullets correspond to outgoing bullets.

Yet in other embodiments, tracking system 104 may provide an alert to an operator on a screen (e.g., display device 102) when the vehicle is close to an object. For instance, display device 102 may indicate the location of the object relative to the vehicle, the distance between the object and a part of the vehicle, a graphical representation of the object, etc. In some embodiments, the indication may be an auditory alert.

According to a still further embodiment, when the tracking system 104 is integrated with a weapon system, such as a gun, the user or operator may adjust the pointing direction of the weapon system according to the track displayed on the display device 102 so as to bring the weapon on target. Alternatively, the weapon system may include an actuator or other mechanism that automatically adjusts the pointing direction of the weapon system according to the track of the moving object detected by the tracking system 104.

One skilled in the art will recognize that other variations of the disclosed embodiments are also within the scope of this disclosure and that they come within the scope of the appended claims and their equivalents. It is intended that the specification and examples be considered as exemplary only, with a true scope and spirit of the invention being indicated by the following claims.

1. A method for detecting a moving object, comprising:
transmitting a continuous waveform signal in a direction of a plurality of projectiles traveling in an outbound direction with respect to a carrier;
receiving a signal reflected from the projectiles in response to the continuous waveform signal; and
determining a track of the projectiles based on the reflected signal.

2. The method of claim 1, further comprising generating an image of the track of the projectiles based on the reflected signal.

3. The method of claim 2, further comprising:
receiving repeatedly signals reflected from the projectile; and
updating the image of the track based on the repeatedly received signals.

4. The method of claim 3, wherein the projectiles comprise bullets discharged from a weapon onboard the carrier.

5. The method of claim 3, further comprising adjusting the weapon according to the track of the projectiles.

6. The method of claim 4, further comprising:
determining locations of individual ones of the bullets; and
generating the image based on the determined locations.

7. The method of claim 4, further comprising:
receiving a position signal indicating a position of the weapon;
generating a representation of the weapon based on the position signal; and
displaying the representation of the weapon with the image of the track.

8. The method of claim 4, further comprising:
receiving a navigational signal indicating a location of a target;
generating a representation of the target based on the navigational signal; and
displaying the representation of the target with the image of the track.

9. The method of claim 1, further comprising adjusting a frequency of the transmitted signal.

10. A system for detecting a moving object, comprising:
a transmitter configured to transmit a continuous waveform signal to a plurality of projectiles traveling in an outbound direction with respect to a carrier of the system;
a receiver configured to receive a reflected signal from the projectiles in response to the continuous waveform signal; and
a processor configured to determine a track of the projectiles based on the reflected signal.

11. The system of claim 10, wherein the processor is further configured to generate image data based on the reflected signal, and the system further comprises a display device configured to receive the image data from the processor and display an image of the track based on the image data.

12. The system of claim 11, wherein the system is attached to a portable weapon onboard the carrier.

13. The system of claim 12, further comprising a position sensor configured to detect a position of the portable weapon and generate a position signal indicating the position of the portable weapon.

14. The system of claim 13, wherein the processor is further configured to receive the position signal and generate a representation of the portable weapon based on the position signal.

15. The system of claim 11, further comprising a communication interface configured to receive a navigational signal indicating a location of a target, and the processor is further configured to generate a representation of the target based on the navigational signal.

16. The system of claim 15, wherein the display device is further configured to display the representation of the target with the image of the track.

17. The system of claim 10, wherein the receiver is configured to receive signals reflected, in response to the continuous waveform signal, from one or more inbound projectiles moving toward the carrier.

18. The system of claim 17, wherein the processor is configured to:
determine a track of the one or more inbound projectiles;
determine a distance between the one or more inbound projectiles and the carrier based on the received signals from the one or more inbound projectiles; and
generate an indication to an operator of the system indicating a proximity of the one or more inbound projectiles to the carrier.

19. A system for simulating detection of a moving object, comprising:
a processor configured to:
generate a simulation signal representing a returned signal reflected from a plurality of simulated projectiles in response to a continuous waveform signal; and
determine a track of the simulated projectiles based on the simulation signal; and
a display device configured to generate a graphical representation of the track.

20. The system of claim 19, wherein the simulation signal represents a simulated reflection of a continuous waveform signal by the simulated projectiles.
